(19) United States
(12) Patent Application Publication
(10) Pub. No.: US 2017/0213168 A1
(43) Pub. Date: Jul. 27, 2017

(54) METHODS AND SYSTEMS FOR OPTIMIZING RISKS IN SUPPLY CHAIN NETWORKS

(71) Applicant: Wipro Limited, Bangalore (IN)

(72) Inventor: Selvakuberan Karuppasamy, Chennai (IN)

(21) Appl. No.: 15/064,844

(22) Filed: Mar. 9, 2016

(30) Foreign Application Priority Data
Jan. 22, 2016 (IN) 201641002487

(51) Int. Cl. G06Q 10/06

(52) U.S. Cl. CPC G06Q 10/0635; G06Q 10/0637

(57) ABSTRACT

A method for optimizing risks in supply chain networks is disclosed. The method includes categorizing, via a risk optimizing device, contextually relevant keywords derived from a user query into a risk category selected from a plurality of risk categories; identifying, via the risk optimizing device, a risk in the supply chain network based on the contextually relevant keywords and the risk category; creating, via the risk optimizing device, a plurality of risk association rules representative of interdependencies of the risk with at least one associated risk; assigning, via the risk optimizing device, priority to each of the plurality of risk association rules based on impact of interdependent risks within corresponding risk association rules; and optimizing a risk association rule assigned high priority within the plurality of risk association rules by removing the risk or one of the at least one associated risk from the risk association rule.

This application claims the benefit of Indian Patent Application Serial No. 201641002487 filed Jan. 22, 2016, which is hereby incorporated by reference in its entirety.

### TECHNICAL FIELD

This disclosure relates generally to supply chain networks and more particularly to methods and systems for optimizing risks in supply chain networks.

### BACKGROUND

Supply chain network is a network of actions followed or practiced to achieve a common goal. The main objective of the supply chain is customer satisfaction. However, when the supply chain network does not work properly or meets the desired objectives, customer satisfaction would suffer. As a result, entire supply chain network will incur huge losses. The challenge is such scenario is to analyze the loss of the supply chain network in order to identify the risk or disruption in the supply chain network.

The process of risk identification in some conventional systems is very time consuming and thus results in customer dissatisfaction or in a worst case scenario causes the customer to leave the supply chain network altogether.

### SUMMARY

In one embodiment, a method for optimizing risks in supply chain networks is disclosed. The method includes categorizing, via a risk optimizing device, contextually relevant keywords derived from a user query into a risk category selected from a plurality of risk categories; identifying, via the risk optimizing device, a risk in the supply chain network based on the contextually relevant keywords and the risk category; creating, via the risk optimizing device, a plurality of risk association rules representative of interdependencies of the risk with at least one associated risk; assigning, via the risk optimizing device, priority to each of the plurality of risk association rules based on impact of interdependent risks within corresponding risk association rules; and optimizing, via the risk optimizing device, a risk association rule assigned high priority within the plurality of risk association rules by removing the risk or one of the at least one associated risk from the risk association rule.

In another embodiment, a system for optimizing risks in supply chain networks is disclosed. The system includes at least one processors and a computer-readable medium. The computer-readable medium stores instructions that, when executed by the at least one processor, cause the at least one processor to perform operations that include categorizing, via a risk optimizing device, contextually relevant keywords derived from a user query into a risk category selected from a plurality of risk categories; identifying, via the risk optimizing device, a risk in the supply chain network based on the contextually relevant keywords and the risk category; creating, via the risk optimizing device, a plurality of risk association rules representative of interdependencies of the risk with at least one associated risk; assigning, via the risk optimizing device, priority to each of the plurality of risk association rules based on impact of interdependent risks within corresponding risk association rules; and optimizing, via the risk optimizing device, a risk association rule assigned high priority within the plurality of risk association rules by removing the risk or one of the at least one associated risk from the risk association rule.

In yet another embodiment, a non-transitory computer-readable storage medium for optimizing risks in supply chain networks is disclosed, which when executed by a computing device, cause the computing device to: categorize, via a risk optimizing device, contextually relevant keywords derived from a user query into a risk category selected from a plurality of risk categories; identify, via the risk optimizing device, a risk in the supply chain network based on the contextually relevant keywords and the risk category; create, via the risk optimizing device, a plurality of risk association rules representative of interdependencies of the risk with at least one associated risk; assign, via the risk optimizing device, priority to each of the plurality of risk association rules based on impact of interdependent risks within corresponding risk association rules; and optimize, via the risk optimizing device, a risk association rule assigned high priority within the plurality of risk association rules by removing the risk or one of the at least one associated risk from the risk association rule.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary computer system for implementing various embodiments;

FIG. 2 is a block diagram illustrating a risk optimizing device for optimizing risks in a supply chain network, in accordance with an embodiment;

FIG. 3 illustrates a flowchart of a method optimizing risks in a supply chain network, in accordance with an embodiment;

FIG. 4 illustrates a flowchart of a method of creating risk association rules in a supply chain network, in accordance with an embodiment;

FIG. 5 illustrates assignment of a likelihood score, a consequence score, and an overall score to risks in a product manufacturing supply chain network to determine risk levels, in accordance with an exemplary embodiment; and

FIG. 6 illustrates a flowchart of a method optimizing risks in a supply chain network, in accordance with another embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

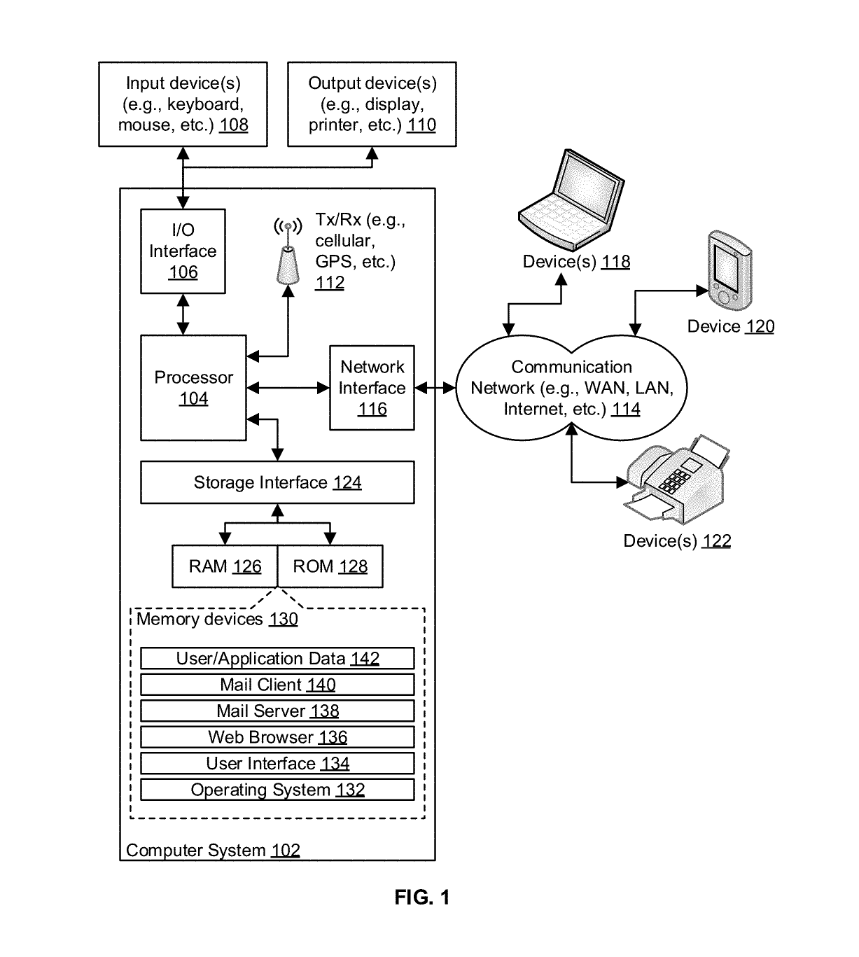

Additional illustrative embodiments are listed below. In one embodiment, a block diagram of an exemplary computer system for implementing various embodiments is disclosed in FIG. 1. Computer system 102 may comprise a central processing unit (“CPU” or “processor”) 104. Processor 104 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. Processor 104 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 104 may be disposed in communication with one or more input/output (I/O) devices via an I/O interface 106. I/O interface 106 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 106, computer system 102 may communicate with one or more I/O devices. For example, an input device 108 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 110 may be a printer, fax machine, video display (e.g., cathode ray tube (CRT), liquid crystal display (LCD), light-emitting diode (LED), plasma, or the like), audio speaker, etc. In some embodiments, a transceiver 112 may be disposed in connection with processor 104. Transceiver 112 may facilitate various types of wireless transmission or reception. For example, transceiver 112 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 104 may be disposed in communication with a communication network 114 via a network interface 116. Network interface 116 may communicate with communication network 114. Network interface 116 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 114 may include, without limitation, a direct interconnection, local area network (LAN), wide area network (WAN), wireless network (e.g., using Wireless Application Protocol), the Internet, etc. Using network interface 116 and communication network 114, computer system 102 may communicate with devices 118, 120, and 122. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 102 may itself embody one or more of these devices.

In some embodiments, processor 104 may be disposed in communication with one or more memory devices (e.g., RAM 126, ROM 128, etc.) via a storage interface 124. Storage interface 124 may connect to memory devices 130 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 130 may store a collection of program or database components, including, without limitation, an operating system 132, a user interface application 134, a web browser 136, a mail server 138, a mail client 140, a user/application data 142 (e.g., any data variables or data records discussed in this disclosure), etc. Operating system 132 may facilitate resource management and operation of the computer system 102. Examples of operating system 132 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 134 may facilitate display, execution, interaction, manipulation, or operation of program components through textual or graphical facilities. For example, user interfaces may provide computer interaction interface elements on a display system operatively connected to computer system 102, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 102 may implement web browser 136 stored program components. Web browser 136 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 102 may implement mail server 138 stored program component. Mail server 138 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 102 may implement mail client 140 stored program component. Mail client 140 may be a mail viewing application, such as Apple Mail, Microsoft Entourage, Microsoft Outlook, Mozilla Thunderbird, etc.

In some embodiments, computer system 102 may store user/application data 142, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

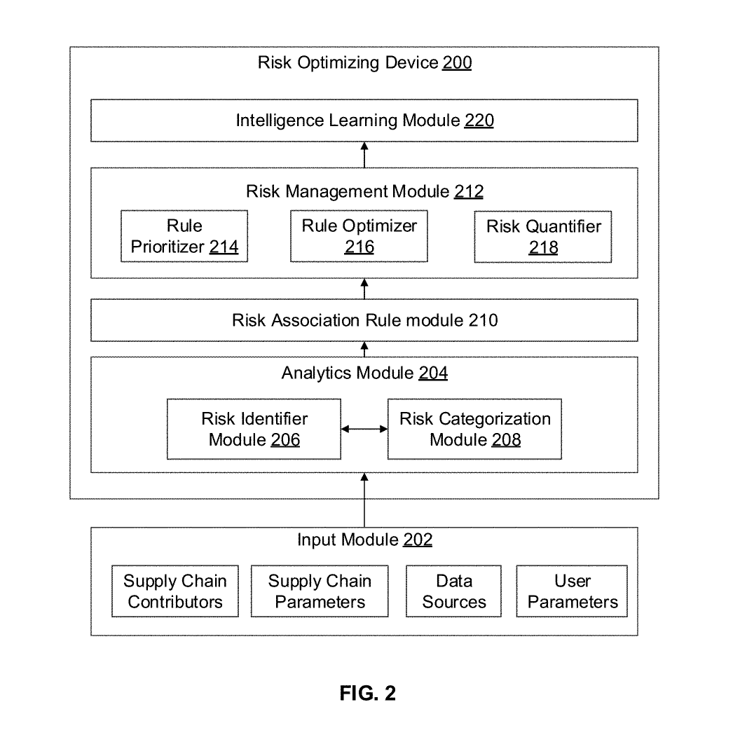

FIG. 2 is a block diagram illustrating a risk optimizing device 200 in a supply chain network, in accordance with an embodiment. Risk optimizing device 200 communicates with an input module 202 to receive a plurality of supply chain inputs associated with the supply chain network. The plurality of supply chain inputs may include, but are not limited to supply chain contributors, supply chain parameters, and supply chain data sources. The supply chain contributors may include, but are not limited to raw material suppliers, manufacturers, whole-salers, retailers, distributors, and the customers. Customers may vary depending upon the type of supply chain network. Further, the supply chain parameters include, but are not limited to supply, demand, transportation, process, storage, information, finance, and environment. The supply chain data sources are selected based on the supply chain parameters.

In addition to receiving the plurality of supply chain parameters, risk optimizing device 200 receives user query as user parameters. The user query is received by an analytics module 204. A risk identifier module 206 in analytics module 204, analyzes the user query using Natural Language Processing (NLP) and text analysis to derive contextually relevant keywords. Thereafter, a risk categorizing module 208 in analytics module 204 categorizes the contextually relevant keywords into a risk category selected from a plurality of risk categories. Based on the contextually relevant keywords and the risk category selected by risk categorizing module 208, risk identifier module 206 identifies a risk in the supply chain network.

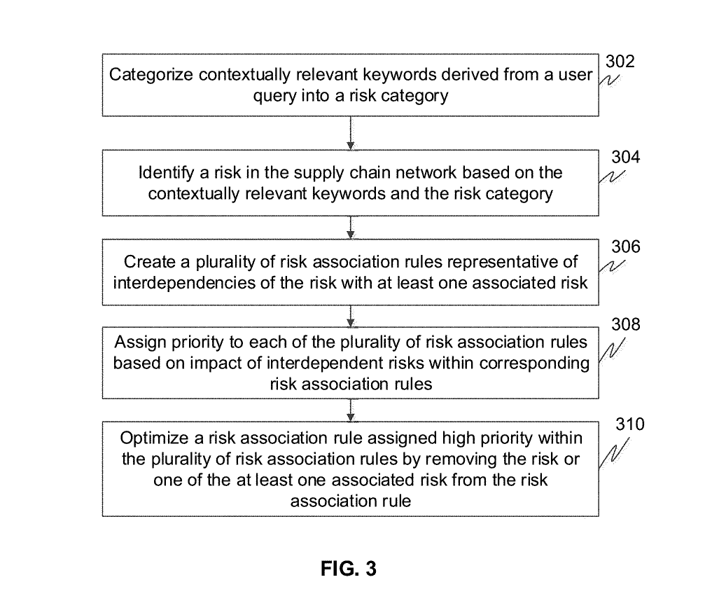

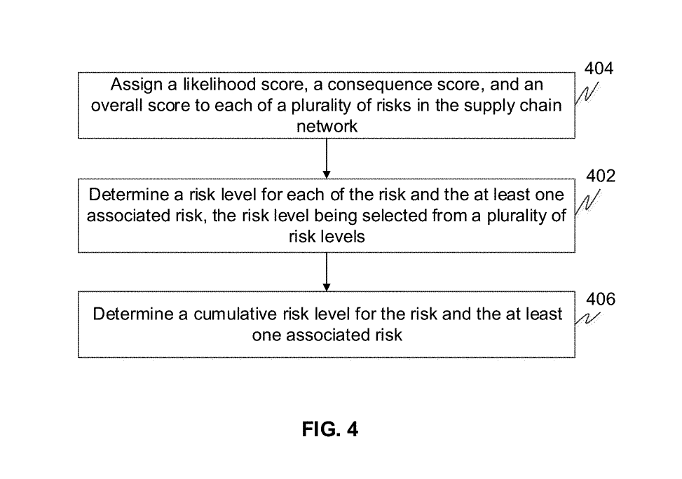

After the risk has been identified, a risk association rule module 210 creates a plurality of risk association rules representative of interdependencies of the risk with at least one associated risk. In an embodiment, a risk association rule is an implication expression of the form X→Y, where X and Y are disjoint item sets, such that, X∩Y=Ø. Strength of a risk association rule may be measured in terms of its support and confidence. Support determines how often a rule is applicable to a given data set, while confidence determines how frequently items in Y appear in transactions that include X. The risk association rules may be framed based on Apriori Itemset generation algorithm for a supply chain network. There are similar algorithms like Elcat, FP Growth that helps in developing association rules. It will be apparent to a person skilled in the art that other similar algorithms are within the scope of the invention. The creation of risk association rules is further explained in detail in conjunction with FIGS. 3 and 4.

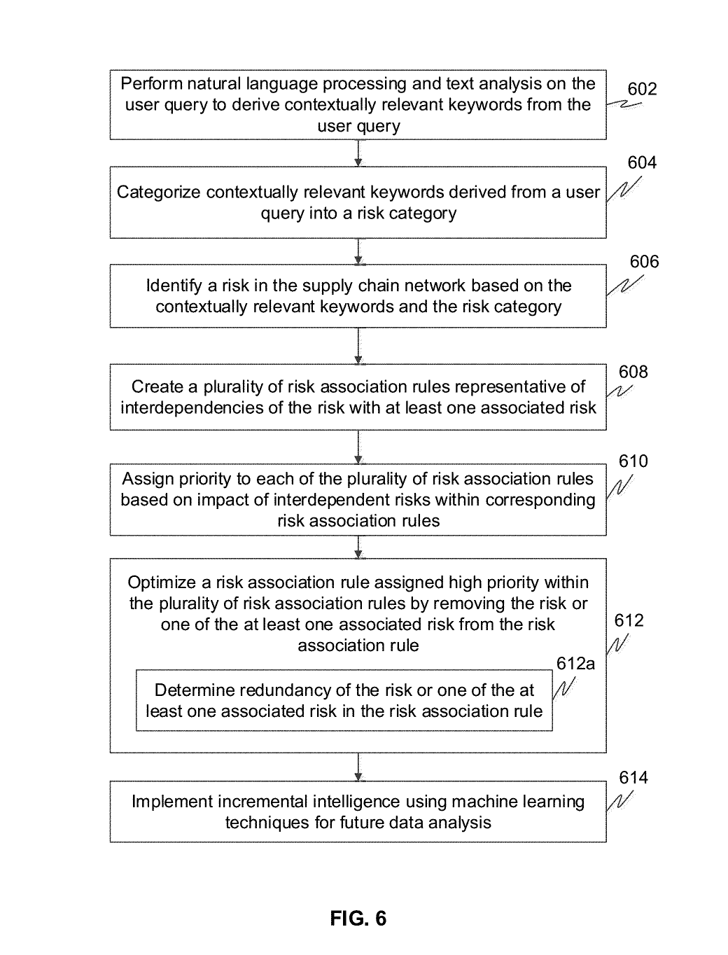

After the plurality of risk association rules have been created, a risk management module 212 prioritizes via a rule prioritizer 214, optimizes via a rule optimizer 216, and quantifies the plurality of risk association rules via a risk quantifier 218. This is further explained in detail in conjucntion with FIG. 3. An intelligence learning module 220 implements incremental intelligence using machine learning techniques for future data analysis. This is further explained in detail in conjucntion with FIG. 6.

FIG. 3 illustrates a flowchart of a method of optimizing risks in a supply chain network, in accordance with an embodiment. To initialize the system in the supply chain network, a plurality of supply chain inputs associated with the supply chain network are received. The plurality of supply chain inputs may include, but are not limited to supply chain contributors, supply chain parameters, and supply chain data sources, the supply chain data sources being selected based on the supply chain parameters. This has been explained in detail in conjunction with FIG. 2 given above.

A risk optimizing device receives a user query. The user query denotes the exact problem description that the user is facing. The user query may include, but is not limited to one or more of an audio query and a text query. The user, for example, may log a ticket with the supply chain network. The ticket may read as: “The price of the mobile phone changes day by day.” The ticket may have been logged either verbally through a user utterance on an audio call or may have been inputted in the form of text from a user device. Examples of the user devices may include but are not limited to a computer, a laptop, a mobile device, a tablet, and a phablet.

The risk optimizing device then performs natural language processing and text analysis on the user query to derive contextually relevant keywords from the user query. In other words, the keywords extracted are such that when these keywords are read in conjunction, they form a relevant context. For example, when the user query is: “The price of the mobile phone changes day by day.” The contextually relevant keywords that are derived are: price, mobile phone, change, day by day. These keywords when read in conjunction set a context that price of the mobile phone changes on a daily basis.

Thereafter, at 306, the risk optimizing device categorizes the contextually relevant keywords into a risk category selected from a plurality of risk categories. A set of objects are clustered into a risk category in such a way that objects in the same risk category are more similar to each other than to those in other risk categories. Categorizing includes finding a structure in a collection of unlabeled data. Each keyword is mapped into each of the plurality of risk categories based on the attributes and the properties of keywords and the risk categories. Further, similarity algorithms are used to calculate distance in order to check which keywords will be fit under each of the plurality of risk categories.

In an embodiment, in a product manufacturing supply chain network, supply chain risks may be categorized under three risk categories, i.e., an external to supply chain risk category, an internal to supply chain risk category, and a management related risk category. Each of these risk categories may be formed by grouping components associated with the product manufacturing supply chain network. This is depicted in Table 1.

TABLE 1

| Risk Category | Components |
|---|---|
| External to supply chain | Finance, Environment |
| Internal to supply chain | Process, Storage, Information |
| Management Related | Supplier, Demand, Transportation |

When the contextually relevant keywords are derived, the risk optimizing device maps these keywords to the plurality of risk categories based on the attributes of these risk categories. In continuation of the example given above, the contextually relevant keywords do not fit either into “Internal the Supply Chain” or “External to the Supply Chain” risk category. Therefore, “Management Related,” is the risk category identified by the risk optimizing device. The risk components for this risk category include: Supplier, Demand, and Transportation. The risk optimization device compares relationship between the contextually relevant keywords with the components of the risk category. Each of the risk component, i.e., supplier, demand, and transportation further has associated risks, which are depicted below:

Supplier—Monopoly, outsourcing, and supplier Outage

Demand—Demand variability, competitors, and product Life cycle

Transportation—Reliability, vehicle capacity, service flexibility

The relationship determined between the contextually relevant keywords is that “price of the mobile phone changes every day.” Thus, “Demand variability” under the Demand risk component is identified as the risk by the risk optimizing device.

After the risk has been identified, risk optimizing device creates a plurality of risk association rules representative of interdependencies of the risk with one or more associated risks at 306. In other words, every risk has a relation or interdependency with other risks, such that, fixing or resolving one of the risk may result in introducing a new risk in the supply chain network. Such scenarios are represented using a risk association rule. For example, in a super market, inventory may be an issue or in other words, there may be no space for accommodating huge inventories. Thus, “Space Issue” is identified by the risk optimizing device as the risk. In this scenario, the risk of “Space issue” may be resolved by using “Just in Time (JIT) arrival of goods” methodology. However, introduction of JIT to resolve the risk of “Space Issue,” would result in increased expenditure in the form of “Transportation costs.” Thus, to effectively manage risks without causing any disruption in the supply chain network, risk association rules are created in order to understand the impact of one risk on other associated risks.

When a risk association rule is created, a risk level is also determined for each of the risk and the one or more associated risks. The risk level is selected from a plurality of risk levels. For example, the plurality of risk levels may include very high risk level, high risk level, medium risk level, low risk level, and very low risk level. One of these risk level may be assigned to a risk and based on that a risk level is assigned to an associated risk. These risk levels are then used to compute a cumulative risk level for the risk and the one or more associated risks. The cumulative risk level also acts as a decision variable. In continuation of the example given above, where “Demand Variability” had been identified as the risk. The associated risks for “Demand Variability” are “Supplier Outage” and “Overhead Costs.” The risk association rules for this example are represented using the Table 2 given below. In this table, each row of the table represents a risk association rule and the risk and the associated risks are assigned different risk levels based on different risk association rules.

TABLE 2

| Supplier | Demand | Overhead | Cumulative Risk |
|---|---|---|---|
| outage | variability | costs | (Decision Variable) |
| high | high | high | high |
| low | high | high | high |
| medium | high | high | high |
| high | medium | high | high |
| low | medium | medium | medium |
| medium | medium | high | high |
| high | low | high | high |
| low | low | low | low |
| medium | low | low | low |

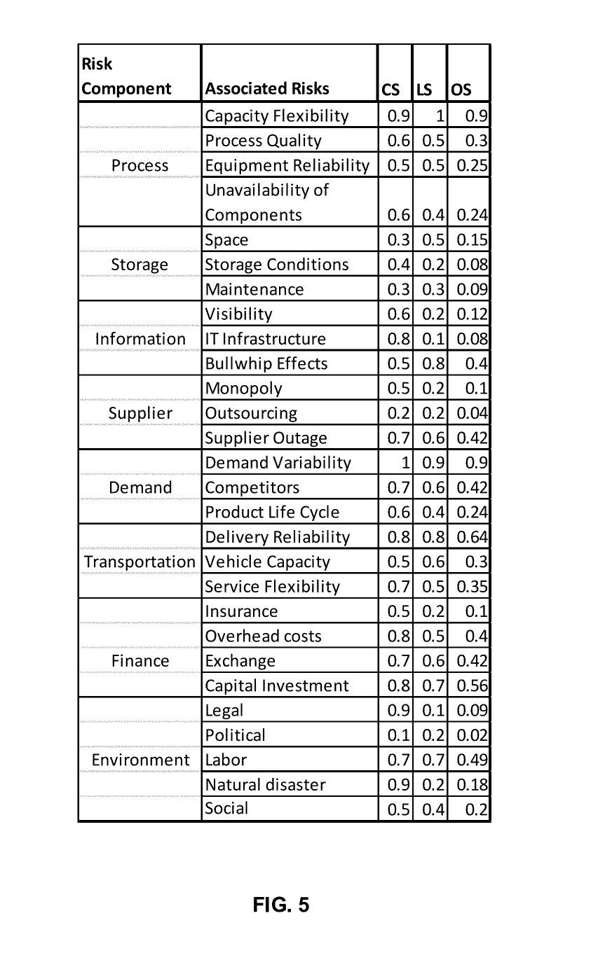

These risk levels may be determined for each of the risk and associated risks by assigning a likelihood score, a consequence score, and an overall score to each of a plurality of risks in the supply chain network. The likelihood score for a risk is representative of number of times of historic occurrence of the risk. The consequence score for the risk is representative of impact of the risk on the supply chain network. The overall score for a risk is a product of the likelihood score and the consequence score assigned to the risk. This is further explained in conjunction with an exemplary embodiment given in FIG. 5.

At 308, the risk optimizing device assigns priority to each of the plurality of risk association rules based on impact of interdependent risks within corresponding risk association rules. In other words, those risk association rules in which the interdependent risks have a high impact are assigned higher priority. In an embodiment, the impact of interdependent risks may be ascertained based on the risk level and the cumulative risk level determined for the risk and the one or more associated risks. In other words, the impact may be determined based on the cumulative risk or the decision variable computed for the risk association rule. Thus, those risk association rules for which the cumulative risk level is high, may be assigned a higher priority as compared to those risk association rules that have their cumulative risk level assigned as medium or low. In continuation of the example given above, the risk association rule given in table 3 are arranged in order of priority, such that, risk association rules having high cumulative risk level are placed first, followed by risk association rules having medium and low cumulative risk level. This prioritization is depicted using the table 3 given below:

TABLE 3

| Supplier | Demand | Overhead | Cumulative Risk |
|---|---|---|---|
| outage | variability | costs | (Decision Variable) |
| high | high | high | high |
| low | high | high | high |
| medium | high | high | high |
| high | medium | high | high |
| medium | medium | high | high |
| high | low | high | high |
| low | medium | medium | medium |
| low | low | low | low |
| medium | low | low | low |

Thereafter, at 310, the risk optimizing device optimizes a risk association rule that has been assigned high priority by removing the risk or one of the one or more associated risks from the risk association rule. In other words, firstly only those risk association rules that have a high cumulative risk level are selected and other risk association rules with medium or low cumulative risk level are ignored or pruned out. In continuation of the example given above, only the first six risk association rules are selected. This is represented by table 4 given below:

TABLE 4

| Supplier | Demand | Overhead | Cumulative Risk |
|---|---|---|---|
| outage | variability | costs | (Decision variable) |
| high | high | high | high |
| low | high | high | high |
| medium | high | high | high |
| high | medium | high | high |
| medium | medium | high | high |
| high | low | high | high |

After selecting those risk association rules for which cumulative risk level is high, the rule optimizing device determines the impact of the interdependent risks in these risk association rules based on the cumulative risk level. As the cumulative risk level for each of these risk association rules is high, the risk optimizing device analyses risk components of the supply chain network in these risk association rules. In continuation of the example given above, those risk association rules in which “Demand Variability” risk and “Overhead Costs” risk are assigned high risk level, are selected and the other risk association rules are pruned out. This may be represented using the table 5 give below:

TABLE 5

| Supplier | Demand | Overhead | Cumulative Risk |
|---|---|---|---|
| Outage | Variability | Costs | (Decision variable) |
| high | high | high | high |
| low | high | high | high |
| medium | high | high | high |

In table 5, the risk level for each of “Demand Variability” risk and the “Overhead Costs” risk is high. Moreover, irrespective of the risk level of the “Supplier Outage” risk being high, low, or medium, the risk level for cumulative risk for each risk association rule is always high. In other words, the risk level of the “Supplier Outage” risk has no impact on the risk level of the cumulative risk. The “Supplier Outage” risk is thus redundant in these three risk association rules and should be removed. As a result, the risk optimizing device removes “Supplier Outage” risk from the risk association rule, thereby, optimizing the risk association rule as represented below:

| Demand | Overhead | Cumulative Risk |
|---|---|---|
| variability | costs | (Decision variable) |
| high | high | high |

The proposed method identifies the supply chain risk by its own intelligence from the user query. Therefore, helps in improving profitability of the supply chain network. This method is a great time saving approach as it reduces manual efforts in tracking the customer ticket logs. The system is also an incremental learning system that meets customer satisfaction in a shorter turnaround time.

FIG. 4 illustrates a flowchart of a method of creating risk association rules in a supply chain network, in accordance with an embodiment. To this end, at 402, a likelihood score, a consequence score, and an overall score to each of a plurality of risks in the supply chain network. The likelihood score for a risk is representative of number of times of historic occurrence of the risk. The consequence score for the risk is representative of impact of the risk on the supply chain network. In an embodiment, the consequent scores for each risk in the supply chain network may be loaded during configuration stage. These consequent scores may be based on risk priorities followed by an organization or enterprise. The overall score for a risk is a product of the likelihood score and the consequence score assigned to the risk. An exemplary assignment of scores in a product manufacturing supply chain network is depicted in FIG. 5.

The risk levels assigned to different risks in the supply chain network are based on the overall score computed for each of these risks. In an example, the overall score may range from 0.00 to 1.00. The level of the score is predefined based on an initial configuration stage. For example, a risk may be considered as “high” level risk if the score is between 0.75-0.90. Generally, the ranges for risks varies based on the enterprises following the supply chain. Thus, at 404, a risk level is determined for each of the risk and the one or more associated risks. The risk level is selected from a plurality of risk levels. Thereafter, at 406, a cumulative risk level for the risk and the one or more associated risks is determined. This has been explained in detail in conjunction with FIG. 3.

FIG. 5 illustrates assignment of a likelihood score, a consequence score, and an overall score to risks in a product manufacturing supply chain network to determine risk levels, in accordance with an exemplary embodiment. In FIG. 5, CS depicts Consequence Score, LS depicts likelihood score, and OS depicts overall score. OS is the product of CS and LS of the respective row.

FIG. 6 illustrates a flowchart of a method of identifying root causes in a supply chain network, in accordance with another embodiment. At 602, the risk optimizing device performs natural language processing and text analysis on a user query to derive contextually relevant keywords from the user query. Thereafter, at 604, the risk optimizing device categorizes contextually relevant keywords into a risk category. At 606, the risk optimizing device identifies a risk in the supply chain network based on the contextually relevant keywords and the risk category. This has been explained in conjunction with FIG. 3.

At 608, the risk optimizing device creates a plurality of risk association rules representative of interdependencies of the risk with one or more associated risks. Thereafter, at 610, the risk optimizing device assigns priority to each of the plurality of risk association rules based on impact of interdependent risks within corresponding risk association rules. At 612, the risk optimizing device optimizes a risk association rule assigned high priority within the plurality of risk association rules by removing the risk or one of the one or more associated risks from the risk association rule. Optimizing includes, determining by the risk optimizing device redundancy of the risk or one of the one or more associated risks in the risk association rule. This has been explained in conjunction with FIG. 3.

At 614, the risk optimizing device implements incremental intelligence using machine learning techniques for future data analysis. The risk optimizing device uses machine learning techniques to monitor the entire system and to learn user's behavior. The risk optimizing device system captures all user queries that are received and creates a mapping of these user queries with the identified risks and subsequently created risk association rules. This enables incremental learning for creation of risk association rules and optimization of the risk association rules to effectively resolve the supply chain risk.

Various embodiments of the invention provide methods and systems for optimizing risks in supply chain networks. The proposed method identifies the supply chain risk by its own intelligence from the user query. Therefore, helps in improving profitability of the supply chain network. This method is a great time saving approach as it reduces manual efforts in tracking the customer ticket logs. The system is also an incremental learning system that meets customer satisfaction in a shorter turnaround time.

The specification has described methods and systems for optimizing risks in supply chain networks. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for optimizing risks in a supply chain network, the method comprising:
categorizing, by a risk optimizing device, contextually relevant keywords derived from a user query into a risk category selected from a plurality of risk categories;
identifying, by the risk optimizing device, a risk in the supply chain network based on the contextually relevant keywords and the risk category;
creating, via the risk optimizing device, a plurality of risk association rules representative of interdependencies of the risk with at least one associated risk;
assigning, by the risk optimizing device, priority to each of the plurality of risk association rules based on impact of interdependent risks within corresponding risk association rules; and
optimizing, by the risk optimizing device, a risk association rule assigned high priority within the plurality of risk association rules by removing the risk or one of the at least one associated risk from the risk association rule.

2. The method of claim 1 further comprising performing natural language processing and text analysis on the user query to derive contextually relevant keywords from the user query.

3. The method of claim 1, wherein creating comprises determining a risk level for each of the risk and the at least one associated risk, the risk level being selected from a plurality of risk levels.

4. The method of claim 3, wherein creating further comprises determining a cumulative risk level for the risk and the at least one associated risk.

5. The method of claim 4, wherein the plurality of risk level is selected from a group comprising very high risk level, high risk level, medium risk level, low risk level, and very low risk level.

6. The method of claim 4, wherein determining the risk level comprises assigning a likelihood score, a consequence score, and an overall score to each of a plurality of risks in the supply chain network, the likelihood score for a risk being representative of number of times of historic occurrence of the risk and the consequence score for the risk being representative of impact of the risk on the supply chain network.

7. The method of claim 4, wherein the impact of interdependent risks is ascertained based on the risk level and the cumulative risk level determined for the risk and the at least one associated risk.

8. The method of claim 4, wherein priority is assigned based on the cumulative risk level.

9. The method of claim 1, wherein optimizing comprises determining redundancy of the risk or one of the at least one associated risk in the risk association rule.

10. The method of claim 1 further comprising implementing incremental intelligence using machine learning techniques for future data analysis.

11. A risk optimizing device comprising:
at least one processors; and
a memory, wherein the memory coupled to the processor which are configured to execute programmed instructions stored in the memory to and that comprise:
categorize contextually relevant keywords derived from a user query into a risk category selected from a plurality of risk categories;
identify a risk in the supply chain network based on the contextually relevant keywords and the risk category;
create a plurality of risk association rules representative of interdependencies of the risk with at least one associated risk;
assign priority to each of the plurality of risk association rules based on impact of interdependent risks within corresponding risk association rules; and
optimize a risk association rule assigned high priority within the plurality of risk association rules by removing the risk or one of the at least one associated risk from the risk association rule.

12. The device of claim 11, wherein the operations further comprise performing natural language processing and text analysis on the user query to derive contextually relevant keywords from the user query.

13. The device of claim 12, wherein the operation of creating comprises operation of determining a risk level for each of the risk and the at least one associated risk, the risk level being selected from a plurality of risk levels.

14. The device of claim 13, wherein the operation of creating further comprises operation of determining a cumulative risk level for the risk and the at least one associated risk.

15. The device of claim 13, wherein the operation of determining the risk level comprises operation of assigning a likelihood score, a consequence score, and an overall score to each of a plurality of risks in the supply chain network, the likelihood score for a risk being representative of number of times of historic occurrence of the risk and the consequence score for the risk being representative of impact of the risk on the supply chain network.

16. The device of claim 14, wherein the impact of interdependent risks is ascertained based on the risk level and the cumulative risk level determined for the risk and the at least one associated risk.

17. The device of claim 14, wherein priority is assigned based on the cumulative risk level.

18. The device of claim 11, wherein the operation of optimizing comprises operation of determining redundancy of the risk or one of the at least one associated risk in the risk association rule.

19. The device of claim 11, wherein the operations further comprise implementing incremental intelligence using machine learning techniques for future data analysis.

20. A non-transitory computer-readable storage medium for optimizing risks in a supply chain network, when executed by a computing device, cause the computing device to:
identify a risk in the supply chain network based on the contextually relevant keywords and the risk category;
create a plurality of risk association rules representative of interdependencies of the risk with at least one associated risk;
assign priority to each of the plurality of risk association rules based on impact of interdependent risks within corresponding risk association rules; and
optimize a risk association rule assigned high priority within the plurality of risk association rules by removing the risk or one of the at least one associated risk from the risk association rule.
